(19) United States
(12) Patent Application Publication
(10) Pub. No.: US 2026/0234410 A1
(43) Pub. Date: Aug. 13, 2026

(54) FEEDSTOCK BLEND FOR SUSTAINABLE CARBON BLACK MANUFACTURING

(71) Applicant: BIRLA CARBON U.S.A., INC., Marietta, GA (US)

(72) Inventor: Seth YOUNG, Marietta, GA (US)

(21) Appl. No.: 19/151,612

(22) PCT Filed: Jan. 30, 2024
(86) PCT No.: PCT/US2024/013497

§ 371 Date: Jul. 28, 2025

Related U.S. Application Data
(60) Provisional application No. 63/482,141, filed on Jan. 30, 2023.

(51) Int. Cl. C09C 1/50

(52) U.S. Cl. CPC C09C 1/50

(57) ABSTRACT

Sustainable feedstock for the production of carbon black.

### BACKGROUND

Kraft pulping constitutes the majority of wood pulp production. The main value stream from the pulping process is cellulose wood pulp, a byproduct of which includes what is known as “black liquor.” Black liquor includes hemicellulose, lignin, tall oil, and turpentine. Historically, black liquor was burned to power paper and pulp mills. Black liquor can also be further processed into additional value streams (e.g., CTO, DTO, TOFA, SLS, turpentine/terpenes, terpene resins, and rosin). As efforts mount to develop sustainable manufacturing processes, black liquor also should be considered a green, renewable, and cost-efficient carbon source.

For instance, during tall oil fractionation, residual tall oil pitch is often used for downstream applications such as mining, pharmaceuticals, and nutraceuticals. In one application, tall oil pitch is used as a valuable source of phytosterols which as used as supplements and in medication useful for reducing blood cholesterol. The sterols in the pitch are also used for the production of pharmaceutical steroids. After extracting sterols from the tall oil pitch, the desterolized pitch becomes a carbon-rich waste stream. A need in the art exists for new methods for preparing carbonaceous material such as carbon black, from renewable and green starting materials.

### SUMMARY

The disclosed sustainable feedstock composition for making carbon black comprises a blend of: (a) a desterolized pitch (e.g., one comprising 10-25% rosin, 50-75% fatty acids, and 10-30% unsaponafiables, each by weight of the desterolized pitch); and (b) a traditional or second carbon black feedstock comprising at least 85% by weight carbon and having a carbon to hydrogen ratio (C:H) ranging from 10:1 to 15:1; wherein the feedstock composition comprises at least 1% desterolized pitch by weight of the composition.

Also described is an improved to a carbon black manufacturing method, the improvement comprising the use of the feedstock composition described above. In addition, described is a method of making carbon black comprising reacting the feedstock composition in a reactor at a temperature sufficient to form carbon black from the feedstock composition.

### DESCRIPTION

Any desterolized pitch can be used with the disclosed blends for carbon black manufacture. In some embodiments, the typical range of desterolized pitch composition will include 10-25% rosin, 50-75% fatty acids, and 10-30% unsaponafiables, each by weight percent of the desterolized pitch. Rosin can include resin acids, particularly abietic acid and abietic-type acids (85-90% by weight of rosin) and pimaric and pimaric-type acids. Unsaponafiables are in general chemicals that cannot be made into a soap (e.g. in the realm of plant-based oils, triglycerides are treated with lye to make a soap). Unsaponafiable content of desterolized pine pitch can be primarily composed of diterpene (C₂₀H₃₂) alcohols and fatty alcohols. See, e.g., Holmbom, B., Erä, V. Composition of tall oil pitch. J Am Oil Chem Soc 55, 342-344 (1978). Abietane is a major diterpene produced by conifers, and abietyl alcohol may represent a significant portion of the unsaponifiable content.

The fatty acid portion of the pitch composition generally comprises a variety of saturated and unsaturated fatty acids, including for example, palmitic acid, stearic acid, oleic acid, 9,12-linoleic acid, 9,11-conjugated linoleic acid, and 9,12-15-linolenic acid. A typical fatty acid portion can comprise 0-5% saturated fatty acids, 30-50% oleic acid, 20-40% linoleic acid, 10-20% conjugated linoleic acid, and 5-15% linolenic acid, each by weight of the fatty acid portion.

The de-sterolized and sustainable feedstock can be blended together with traditional carbon black feedstock and used in the manufacture of carbon black and other carbonaceous materials. In one embodiments, the blended feedstock composition comprises a blend of (a) desterolized pitch comprising 10-25% rosin, 50-75% fatty acids, and 10-30% unsaponafiables, each by weight of the desterolized pitch; and (b) a traditional carbon black feedstock comprising at least 85% by weight carbon and having a carbon to hydrogen ratio (C:H) ranging from 10:1 to 15:1. The desterolized pitch can be present in the feedstock composition in an amount of at least 1% by weight of the composition.

In a further embodiment, the blended feedstock composition can comprise up to 50% desterolized pitch by weight of the composition. In other embodiments, the blended feedstock composition can comprise 5% to 50% desterolized pitch by weight of the composition. In various embodiments, the crude oil feedstock constitutes the balance of the weight percent of the composition.

In various embodiments, the second feedstock can be any feedstock traditionally used for carbon black manufacture, regardless of its source. Non-limiting examples include crude oil feedstock, petroleum cracker products, heavy aromatic oils, coal tar, cresote, anthracene oil, ethylene tar, acetylene, natural gas, naphtha, gas oil, or any combination thereof.

In some embodiments, the blended feedstock composition comprises at least 80% carbon by weight of the composition. In additional embodiments, the blended feedstock composition has a carbon to oxygen ratio (C:O) ranging from 10:1 to 99:1. In a further embodiments, the blended feedstock composition has a carbon to oxygen ratio (C:O) ranging from 20:1 to 35:1.

As discussed above, the blended feedstock composition can be used as starting material for the manufacture of carbonaceous material such as carbon black. In one aspect, the improvement in the manufacturing method which can include any method known to one of skill in the art comprises the use of the feedstock composition described in this application.

In a further aspect, the method of making carbon black can comprise reacting the feedstock composition in a reactor at a temperature sufficient to form carbon black from the feedstock composition. Carbon black is generally produced by the partial oxidation or thermal decomposition of hydrocarbon gases or liquids, i.e., those present in the blended feedstock composition. A broad range of carbon black types can be made by controlled manipulation of the reactor conditions. The carbon black formation reaction in the furnace can be controlled by quenching, such as by steam or water spray. The carbon black particles produced can be conveyed through the reactor, cooled, and continuously collected, such as via filters.

The carbon black material of the present invention can be made using techniques generally known in the carbon black art. One particular method of making the carbon black is described in Example 1 of U.S. Pat. No. 7,238,741, which is incorporated into this application by reference for its teachings of carbon black production methods. Variations on this method can be determined by one of skill in the art.

The carbon blacks can be produced in a carbon black tread reactor having a combustion section and a reaction section. An example reactor suitable for use in production of the blacks is described generally in U.S. Pat. Nos. 4,927,607 and 5,256,388, the disclosures of which are hereby incorporated by reference in their entireties. Other carbon black reactors can be used. One of skill in the art can determine an appropriate reactor for a particular application. The sections of the reactor need not be distinct physical sections, but can instead be areas within the reactor performing the correct functions. All or part of the blended feedstock may be injected into the hot combustion stream from the combustion section. The feedstock can be injected radially or axially to the walls of the reactor. The location of the feedstock injection(s) is generally located upstream of or within the choke section or the reactor. This mixture passes to the reaction zone. A quench section follows which slows and/or stops the reaction. The location of the quench is generally downstream of the exit of the choke section. The reaction is stopped when the carbon black of the present invention has been formed.

After being quenched, the carbon black and gases can be further cooled and separated. Essentially any conventional cooling and separating methods can be used. The separation is often achieved using a bag filter. The carbon black can be further readied for use, storage, or shipping. For example, carbon black is often pelletized using, for example, wet beading. Downstream processing is not critical to the carbon blacks of the present invention. One of skill in the art can determine appropriate downstream processing for a particular application.

### EXAMPLES

The following examples further illustrate this disclosure. The scope of the disclosure and claims is not limited by the scope of the following examples.

The following blends were prepared with traditional carbon black feedstock blended with sustainable desterolized pitch feedstock. Traditional carbon black feedstock properties are shown below in Table 1.

TABLE 1

| | FCC | Ethylene Tar | Coal Tar |
|---|---|---|---|
| BMCI | 130 | 130 | 160 |
| API Gravity | −3.5 | −2.0 | −7.5 |
| Viscosity SUS @ 210 F. | 70 | 70 | <100 |
| Ash, wt % (hard black) | 0.02 | 0.02 | <0.15 |
| Ash, wt % (soft black) | 0.02 | 0.02 | <0.15 |
| Sediments by extraction, wt % | 0.1 | 0.1 | 0.1 |
| Water by distillation, wt % | 0.1 | 0.1 | 0.5 |
| Asphaltenes, wt % (MRG) | 3 | 6 | 6 |
| Asphaltenes, wt % (tread) | 5 | 6 | 6 |
| Sulfur, wt % | 2.0 | <1 | <1 |
| Carbon, wt % | 90 | 92 | 92 |
| C/H ratio | 12.5 | 13 | 12.5 |
| Flash Point, ° C. | >100 | >100 | >100 |
| K, ppm | 2 | 2 | 2 |
| Na, ppm | 5 | 5 | <10 |
| V, ppm | 6 | 6 | <8 |
| Si, ppm | 20 | 20 | 20 |
| Al, ppm | 20 | 20 | 20 |

Five blends were prepared with traditional carbon black feedstock together with desterolized pitch feedstock. The blends are summarized below in Table 2.

TABLE 2

| wt % | | | | | | 625M | | | | | |
|---|---|---|---|---|---|---|---|---|---|---|---|
| Waste | SG | | | Saybolt | Alcor | Res. | Ash | Sulfur | Sodium | Iron | Carbon |
| Pitch | g/cm³ | ° API | BMCI | SUS | % | ppm | % | % | ppm | ppm | % |
| 0 | 1.09 | −1.8 | 127 | 94 | 9.2 | 0 | 0.04 | 2.67 | 2 | 4 | 88.9 |
| 5 | 1.09 | −0.8 | 123 | 95 | 8.5 | 0 | 0.04 | 2.53 | 31 | 4 | 88.4 |
| 10 | 1.08 | −0.1 | 121 | 107 | 8.8 | 0 | 0.06 | 2.42 | 65 | 6 | 88.1 |
| 25 | 1.06 | 2.3 | 109 | 129 | 8.3 | 0 | 0.09 | 2.12 | 155 | 11 | 86.5 |
| 50 | 1.04 | 4.1 | 101 | 184 | 7.1 | 0 | 0.16 | 1.55 | 312 | 23 | 84.0 |

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

What is claimed is:

1. A feedstock composition for making carbon black, comprising a blend of:
a) A desterolized pitch; and
b) a second feedstock comprising at least 85% by weight carbon and having a carbon to hydrogen ratio (C:H) ranging from 10:1 to 15:1;
wherein the feedstock composition comprises at least 1% desterolized pitch by weight of the composition.

2. The composition of claim 1, wherein the desterolized pitch comprises 10-25% rosin, 50-75% fatty acids, and 10-30% unsaponafiables, each by weight of the desterolized pitch

3. The composition of claim 1, comprising up to 50% desterolized pitch by weight of the composition.

4. The composition of claim 1, comprising 5% to 50% desterolized pitch by weight of the composition.

5. The composition of any preceding claim, wherein the second feedstock constitutes the balance of the weight percent of the composition.

6. The composition of any preceding claim, wherein the second feedstock comprises crude oil feedstock, petroleum cracker products, heavy aromatic oils, coal tar, cresote, anthracene oil, ethylene tar, acetylene, natural gas, naphtha, gas oil, or any combination thereof.

7. The composition of claim 2, wherein the rosin comprises abietic acid, pimaric acid, any derivative thereof, or a combination thereof.

8. The composition of claim 7, wherein the rosin comprises 85-90% by weight abietic acid and abietic acid derivatives by weight of the rosin.

9. The composition of claim 2, wherein the unsaponafiables comprise diterpene, alcohols, fatty alcohols, or a combination thereof.

10. The composition of claim 9, wherein the unsaponafiables comprise abietyl alcohol.

11. The composition of claim 2, wherein the fatty acids comprise saturated fatty acids, palmitic acid, stearic acid, oleic acid, 9,12-linoleic acid, 9,11-conjugated linoleic acid, 9,12,15-linolenic acid, or a combination thereof.

12. The composition of claim 11, wherein the fatty acids comprise up to 5% saturated fatty acids, 30-50% oleic acid, 20-40% linoleic acid, 10-20% conjugated linoleic acid, and 5-15% linolenic acid, each by weight of the fatty acids.

13. The composition of claim 1, comprising at least 80% carbon by weight of the composition.

14. The composition of claim 1, which has a carbon to oxygen ratio (C:O) ranging from 10:1 to 99:1.

15. The composition of claim 14, which has a carbon to oxygen ratio (C:O) ranging from 20:1 to 35:1.

16. In a carbon black manufacturing method, the improvement comprising the use of the feedstock composition of claim 1.

17. A method of making carbon black comprising reacting the feedstock composition of claim 1 in a reactor at a temperature sufficient to form carbon black from the feedstock composition.
